(19) United States
(12) Patent Application Publication
(10) Pub. No.: US 2014/0300954 A1
(43) Pub. Date: Oct. 9, 2014

(54) LIGHT SHIELDING DEVICE OF CAMERA

(71) Applicant: Ingrasys Technology Inc., Taoyuan (TW)

(72) Inventor: SHU-YUN HUANG, Taoyuan (TW)

(73) Assignee: INGRASYS TECHNOLOGY INC., Taoyuan (TW)

(21) Appl. No.: 14/050,371

(22) Filed: Oct. 10, 2013

(30) Foreign Application Priority Data
Apr. 8, 2013 (TW) 102112421

(51) Int. Cl. G03B 11/04

(52) U.S. Cl. CPC G03B 11/04
USPC 359/350

(57) ABSTRACT

A light shielding device for a camera includes a light board and a light shielding member. The light board defines a first through hole in a center. A number of infrared lamps mounted on a side of the light board and around the through hole. The shielding member is mounted to the light board and includes a main body positioned between the infrared lamps and the through hole.

### BACKGROUND

1. Technical Field

The present disclosure relates to a light shielding device.

2. Description of Related Art

Infrared lamps are often mounted to light boards of cameras to light for the camera. However, because the lens cones extend through the light boards, the light of the infrared lamps may disperse to the lens cones. As a result, the images that the cameras took may lack fidelity.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a light shielding device.

FIG. 2 is an assembled, isometric view of FIG. 1.

FIG. 3 is a cross-sectional view of FIG. 2, taken along the line III-III.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

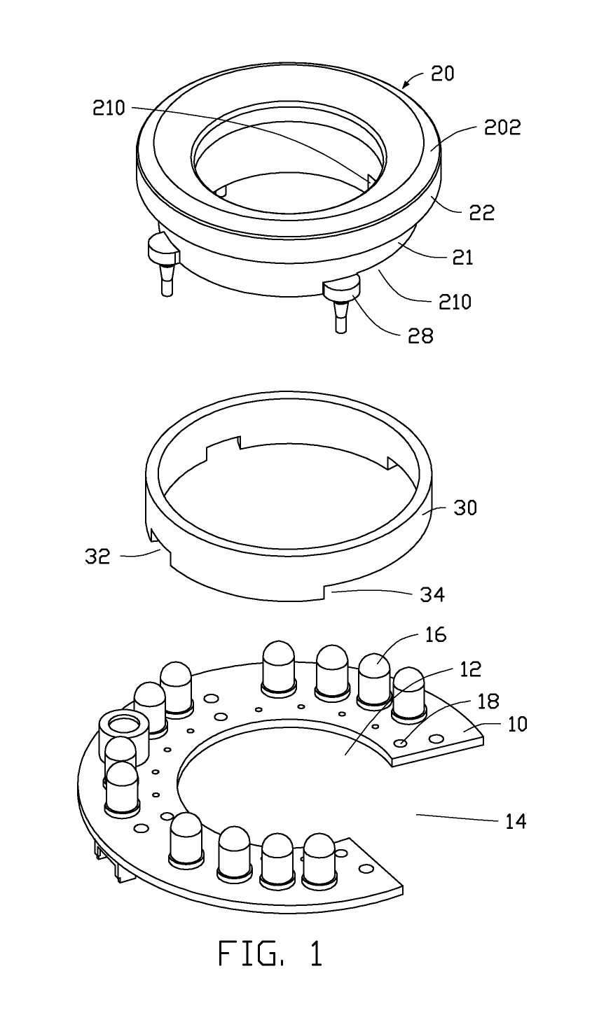

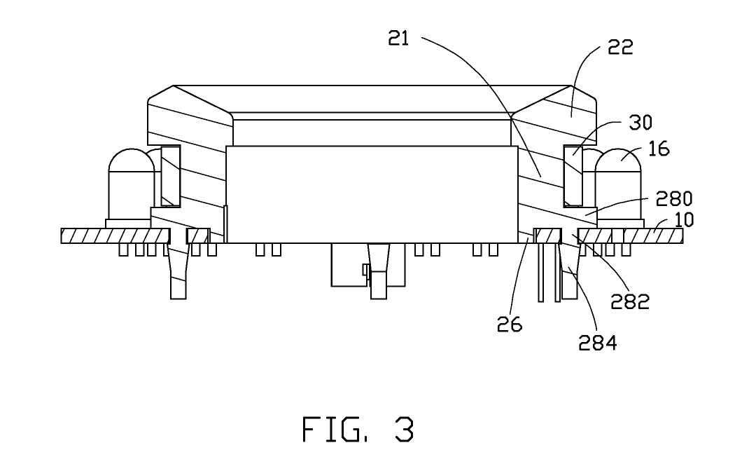

FIGS. 1 and 3 show an exemplary embodiment of a light shielding device. The light shielding device includes a round light board 10 of a camera, a shielding member 20, and a pliable member 30.

The light board 10 defines a round through hole 12 in a center to allow a lens cone (not shown) of the camera to extend through. The light board 10 defines an opening 14 communicating with the through hole 12 and extending through the circumference of the light board 10, facilitating the user to adjust the lens cone. The light board 10 defines a plurality of fixing holes 18 around the through hole 12. A plurality of infrared lamps 16 is mounted on a top surface of the light board 10 and around the fixing holes 18.

The shielding member 20 includes a hollow and columnar main body 21 greater than the infrared lamps 16 in height. An extension portion 22 perpendicularly extending out from a top of the main body 21, an inserting portion 26 extending down from a bottom of an inner surface of the main body 21, and a plurality of fixing portions 28 are mounted to a bottom of an outer surface of the main body 21.

The extension portion 22 forms a chamfer 202 on a top surface to tightly engage with a dome cover (not shown) receiving the light board 10, to prevent light from escaping out through a gap between the dome cover and the extension portion 22.

The main body 21 defines a cutout 210 in a lower portion.

Each fixing portion 28 includes a block 280 protruding from the outer surface of the main body 21, a rod 282 connected to a bottom of the block 280, a tapered locking portion 284 connected to a bottom of the rod 282. A diameter of the rod 282 is less than a diameter of the block 280 and a diameter of an upper portion of the locking portion 284. The locking portion 284 is pliable.

The pliable member 30 is annular and is made of flexible materials, such as rubber. The pliable member 30 is fitted about the main body 21, to help the main body 21 to engage with the dome cover tightly. The pliable member 30 defines a plurality of receiving holes 32 to receive the blocks 280, and a cutout 34 aligning with the cutout 210. In another embodiment, the pliable member 30 can be omitted.

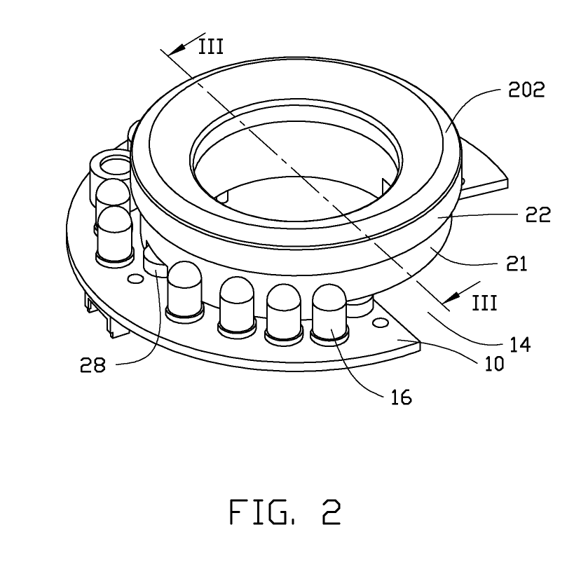

FIGS. 2 and 3 show that in assembly, the inserting portion 26 is extended through the through hole 12. The locking portions 284 are deformed to be extended through the fixing holes 18, until the blocks 280 rest on the top surface of the light board 10. The locking portions 284 are restored and abut a bottom surface of the light board 10, thereby fixing the shielding member 20 to the light board 10. The main body 21 is located between the through hole 12 and the infrared lamps 16, to prevent light of the infrared lamps 16 from dispersing to the lens cone extending through the through hole 12.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A light shielding device, comprising:
a light board defining a through hole in a center, wherein a plurality of infrared lamps is mounted on a top surface of the light board and around the through hole; and
a shielding member mounted to the light board and comprising a hollow and columnar main body located between the through hole of the light board and the plurality of infrared lamps; wherein the main body is greater than the plurality of infrared lamps in height.

2. The light shielding device of claim 1, wherein an inserting portion extends down from a bottom of the main body to be extended through the through hole.

3. The light shielding device of claim 1, wherein a plurality of fixing members is mounted to an outer surface of the main body, the plurality of fixing members is engaged in the light board.

4. The light shielding device of claim 3, wherein the light board defines a plurality of fixing holes between the through hole and the plurality of infrared lamps, each fixing member comprises a block rested on the top surface of the light board, a rod engaged in one of the fixing holes, and a tapered locking portion pliable to extend through the corresponding fixing hole and then abutting a bottom surface of the light board.

5. The light shielding device of claim 4, wherein the shielding member further comprises a pliable member fitted about the main body.

6. The light shielding device of claim 5, wherein the pliable member defines a plurality of cutouts to receive the blocks.

7. The light shielding device of claim 1, wherein an extension portion perpendicularly extending out from a top of the main body.

8. The light shielding device of claim 7, wherein the extension portion forms a chamfer on a top surface.

9. The light shielding device of claim 1, wherein the light board defines an opening communicating with the through hole and extending through a circumference of the light board.

10. The light shielding device of claim 10, wherein the main body defines a cutout in a lower portion, the cutout aligns with the opening.
